(19) United States
(12) Patent Application Publication
(10) Pub. No.: US 2020/0223669 A1
(43) Pub. Date: Jul. 16, 2020

(54) APPARATUS AND METHOD FOR LIFTING HEAVY LOADS

(71) Applicant: Mazzella Lifting Technologies, Inc., Cleveland, OH (US)

(72) Inventor: Tony D'Angela, Cleveland, OH (US)

(73) Assignee: Mazzella Lifting Technologies, Inc., Cleveland, OH (US)

(21) Appl. No.: 16/735,122

(22) Filed: Jan. 6, 2020

Related U.S. Application Data
(60) Provisional application No. 62/792,675, filed on Jan. 15, 2019.

(51) Int. Cl. B66C 1/42

(52) U.S. Cl. CPC B66C 1/427

(57) ABSTRACT

An apparatus for lifting and manipulating a heavy load by way of at least one pair of tongs and at least one hydraulic cylinder is disclosed. The load lifting apparatus may be configured such that it includes a first linkage, consisting of two pivotal linkage members, and a second linkage, having two pivotal linkage members. The load lifting apparatus may further have a set of tongs which includes two tong arms, and a hydraulic cylinder capable of actuating about one of the pivot points of the linkages. This configuration allows for the distance between the two tong arms to be adjusted according to the relative size of the load being engaged by the load lifting apparatus. A controller may actuate the hydraulic cylinder to adjust the distance between the tong arms.

This non-provisional application claims priority to U.S. Provisional Patent Application Ser. No. 62/792,675, filed on Jan. 15, 2019.

### TECHNICAL FIELD

The present disclosure relates to an apparatus and method for lifting heavy objects and loads. More particularly, an apparatus having adjustable tongs capable of grasping a heavy object for transport. Specifically, a pair of hydraulically-actuated tongs capable of expanding their width relative to an associated load to be lifted and capable of being affixed to an associated lifting device for transport of the load.

### BACKGROUND

Lift devices are used throughout a wide variety of industries for a number of different applications. For example, lift devices may be small and compact, capable of being easily transported and used with ease for lifting a number of different objects, or may alternatively be large, bulky equipment designated for a singular use, such as the lifting of heavy dies or machinery. It is this latter of the two with which the present disclosure is concerned.

It is known in the art for lifting apparatuses generally to use linkages as a means of combining different members such that they are capable of pivoting or rotating about one another. Such linkages have previously been used in conjunction with cranes and other associated lifting equipment, such as to help grip and then selectively release heavy loads. The present invention provides methods and apparatuses for lifting heavy loads through such linkages which are equipped with a hydraulically-actuated power-assist to aid the apparatus in both opening and closing., as well as for better gripping and releasing of the load.

### SUMMARY

According to one aspect of the present invention, a new and improved lifting mechanism is provided which provides better and improved performance. One advantage of this invention is more effective securement and then releasage of loads. Still other benefits and advantages of the invention will become apparent to those skilled in the art to which it pertains upon a reading and understanding of the following detailed specification.

According to one aspect of the present invention, a load lifting apparatus may be configured such that it includes a first linkage, consisting of two pivotal linkage members, and a second linkage, having two pivotal linkage members. The load lifting apparatus may further have a set of tongs which includes two tong arms, and a hydraulic cylinder capable of actuating about one of the pivot points of the linkages. This configuration allows for the distance between the two tong arms to be adjusted according to the relative size of the load being engaged by the load lifting apparatus.

According to another aspect of the present invention, a method of manipulating a load via a load lifting apparatus may include a first step of attaching a load lifting apparatus to an associated lifting device. The load lifting apparatus may comprise a transverse support member to which the lifting device is attached. The load lifting apparatus may be configured such that it includes a first linkage, consisting of two pivotal linkage members, and a second linkage, having two pivotal linkage members. The load lifting apparatus may further have a set of tongs which includes two tong arms, and a hydraulic cylinder capable of actuating about one of the pivot points of the linkages. The distance between the tong arms may be adjusted relative to the width of the load. The tong arms are then placed around the load, and the distance between the tong arms is then readjusted to firmly engage the load. The lifting apparatus is then operated so as to manipulate the load.

Another aspect of the present invention provides a load lifting apparatus with a transverse support member to which the lifting device is attached. The load lifting apparatus may be configured such that it includes a first linkage, consisting of two pivotal linkage members, and a second linkage, having two pivotal linkage members. The load lifting apparatus may further have a set of tongs which includes two tong arms, and a hydraulic cylinder capable of actuating about one of the pivot points of the first or second linkages. Third and fourth linkages, each consisting of two pivotal linkage members, are further included, as well as a second set of tongs comprising two tong arms. A second hydraulic cylinder capable of actuating about one of the pivot points of the third and fourth linkages is further provided. The hydraulic cylinders allow for the distance between the different tong arms to be adjusted.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of the apparatus showing its features;

FIG. 2 is an end view of the apparatus; and,

FIG. 3 is a side view of the apparatus.

### DETAILED DESCRIPTION

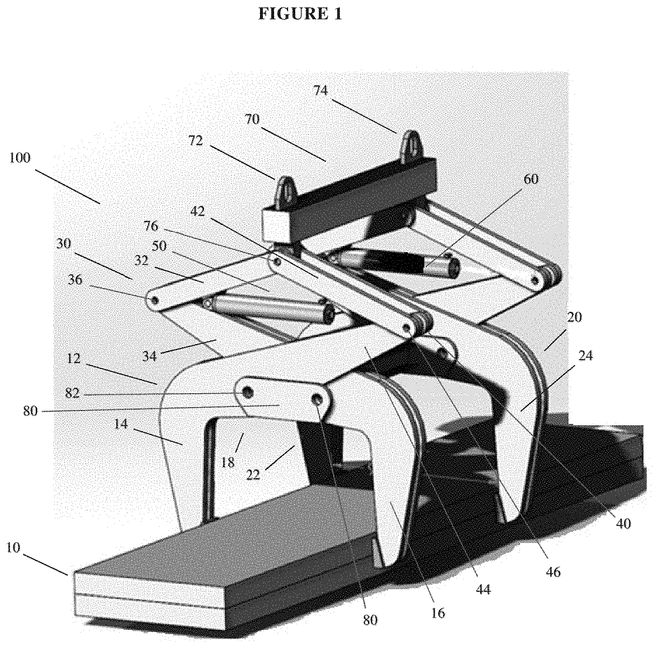

Referring now to the drawings wherein the showings are for purposes of illustrating embodiments of the invention only and not for purposes of limiting the same, FIG. 1 shows the apparatus and perspective view. The different elements of the apparatus will now be briefly described.

An associated load 10 is shown to illustrate the function of the heavy load lifting apparatus 100, but is not part of the claimed invention. In operation, the load 10 can be large or small or take different configurations, but is often a fairly large load, too heavy to be lifted by a human without mechanical assistance, such as shown in the apparatus 100.

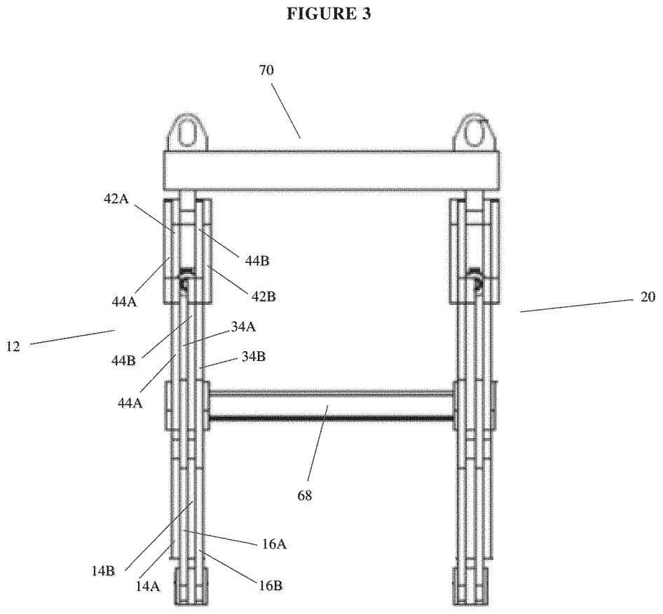

With continuing reference to FIG. 1, the apparatus 100 has a first set of tongs 12 which includes a first tong arm 14 and a second tong arm 16. The first and second tong arms 14 and 16 are spaced apart from one another, with the interior face of each respective tong arm facing the opposing interior face and the tong arms running substantially parallel to one another. The apparatus 100 additionally contains a second set of tongs 20 which includes a first tong arm 22 and a second tong arm 24. The first and second set of tongs 12, 20 are operatively linked together through fairly conventional means, such as connecting member 68 as shown in FIG. 3 and discussed in greater detail throughout the remainder of the present disclosure. According to certain embodiments, the opposing interior faces of the respective tong arms may be equipped with a gripping device, such as a padding or other similar design, in order to aid the gripping ability of the tong arms, as well as protect the associated load from being marred or otherwise damaged during use.

For the remainder of the present disclosure, the configuration and functionality of the first sets of tongs 12 will be discussed. It is to be understood by those having skill in the art that the second set of tongs 20 will be of the same general configuration and functionality as that of the first set of tongs 12, unless stated otherwise. Thus, when the first and second tongs arms 14, 16 of the first set of tongs 12 are discussed, it is to be understood that the first and second tongs arms 22, 24 of the second set of tongs 20 are of similar configuration and functionality.

The first and second tongs 12, 20 operate in a conventional manner, capable of being moved either closer to, or further away from, one another. The interior face of each of the respective tong arms 14, 16 are capable of contacting a load 10 upon being moved closer to one another. The mechanism which allows for movement of the first and second tong arms 14, 16 is that of a first linkage 30, having first and second linkage members 32, 34, and a second linkage 40, having first and second linkage members 42, 44. Each of the second linkage members 34 and 44 are an extension of the second and first tong arms 16 and 14, respectively. As the second linkage members 34 and 44 extend further away from that of the respective tong arms 14, 16, the width of each of the second linkage members 34, 44 may generally decrease. Affixed to the end of each of the second linkage members 34, 44 is the respective first linkage member 32, 42.

The first and second tong arms 14, 16, as well as each of the respective linkage members 32, 34, 42, 44, may each be constructed by a series of two similarly dimensioned components, or plates, which are joined together by a fastener, leaving a gap between the respective faces of the components such that they do not directly contact one another. According to one embodiment, the plates are arranged according to an interlocking design, wherein the respective plates are alternated with one another. For example, the first tong arm 14 may consist of two spaced apart plates, the second tong arm 16 may consist of two spaced apart plates, with the first plate of the second tong arm 16 positioned between that of the two plates of the first tong arm 14, and the second plate of the second tong arm 16 positioned on the reverse, or back, side of the first tong arm 14. This configuration may similarly extend to the various linkage members.

Each of the respective parings of linkage members are rotationally connected about a pivot point. In the embodiment shown in FIG. 1, the first linkage 30 has a first linkage pivot point 80 which allows for the first and second linkage members 32, 34 to rotate relative to one another. The pivot points which allow for the rotational movement of the respective linkages may be of any type as identified by those having skill in the art. For example, the first linkage pivot point 80 as shown in FIG. 1 consists of a fastener capable of being inserted through a series of openings in the first linkage member 32, as well as through an opening in the second linkage member 34, with the second linkage member 34 also being at least partially inserted within said openings in the first linkage member 32. In a similar manner, a second linkage pivot point 46 joins together the first and second linkage members 42, 44 of the second linkage 40.

With continuing reference to FIG. 1, each of the first and second tong arms 14 and 16 have an approximate 90° bend located in substantially the same plane as one another, converging about a first interior face 18. The effective length of the first interior face 18 is variable according to the interaction between the first and second tong arms 14, 16, as discussed in greater detail below. Following the approximate 90° bend, the first tong arm 14 will transition into a second linkage member 44 of the second linkage; similarly, the second tong arm 16 will transition into a second linkage member 34 of the first linkage. According to this configuration, the first tong arm 14 of the first set of tongs 12 and the second linkage member 44 of the second linkage 40 will be substantially a single component wherein following the approximate 90° bend, the second linkage member 44 of the second linkage 40 extends away from that of the first tong arm 14 at an obtuse angle. This design causes movement of the second linkage member 44 to directly result in movement of the first tong arm 14. Similarly, the second tong arm 16 of the first set of tongs 12 and the second linkage member 34 of the first linkage 30 will be substantially a single component wherein following the approximate 90° bend, the second linkage member 34 of the first linkage 30 extends away from that of the second tong arm 16 at an obtuse angle. This design causes movement of the second linkage member 34 to directly result in movement of the second tong arm 16.

Similarly to the configuration of the first and second linkages 30, 40 responsible for the rotational movement about the first and second linkage pivot points 36, 46 of the first set of tongs 12, the second set of tongs 20 is of a similar configuration. According to the embodiment shown in FIG. 1, each of the corresponding features of the second set of tongs 20 are of a similar design and dimensions to that of the corresponding feature on the first set of tongs 20.

With continued reference to FIG. 1, each of the first and second linkages 30, 40 may be affixed to a transverse support member 70 at a first end, and the corresponding linkage members of the second set of tongs 20 may be affixed at the opposing distal end, each retaining some form of pivotal rotation about the points of securement. According to the embodiment shown in FIG. 1, the first and second linkages 30, 40 are affixed according to a similar configuration as that of the connection between the first and second linkage members 32, 34 via the first linkage pivot point 36 (and, therefore, the first and second linkage members 42, 44 via the second linkage pivot point 46). A first anchoring pivot point 76 consists of a fastener capable of being inserted through a series of openings in the first linkage member 42 of the second linkage 40, located about the opposing end to that of the second pivot point 46, as well as through an opening in the first linkage member 32 of the first linkage 30, with the first linkage member 32 also being inserted at least partially within said openings in the first linkage member 42. A securement point which extends away from the transverse support member 70 receives the fastener, creating the first anchoring pivot point 76. In a similar manner, a second anchoring pivot point is located about the opposing distal end of the transverse support member 70 and allows for the pivotal securement of the second set of tongs 20 to the transverse support member 70.

The transverse support member 70 has first and second eyelets 72, 74 affixed to opposing distal ends and extending upward and away from that of the respective anchoring pivot points, such as the first anchoring pivot point 76. An associated lifting apparatus, such as a crane, may be attached to the first and second eyelets, 72, 74. When the associated lifting apparatus lifts the transverse support member 70 upwardly, this upward force causes the first linkage members 32, 42 of the respective first and second linkages 30, 40 to pivot about the first anchoring pivot point 76. This pivoting or rotational movement causes the respective first linkage members 32, 42 to extend longitudinally such that they begin to approach a perpendicular relationship to that of the transverse support member 70. The extent of rotational movement about the first anchoring pivot point 76 may be controlled by additional features of the first set of tongs 12, as discussed in greater detail throughout the remainder of this disclosure.

As the first linkage members 32, 42 rotate about the first anchoring pivot point 76, the upward lifting force by the associated lifting apparatus will also cause the second linkage members 34, 44 to pivot about the first and second linkage pivot points, 36, 46. This rotational movement causes the second linkage members 34, 44 to begin to extend in a direction which is of a perpendicular relation to that of the transverse support member 70. If the rotational movement about the various pivot points 36, 46, and 76 were uninhibited, the first and second linkage members 32, 34 of the first linkage 30 and the first and second linkage members 42, 44 of the second linkage 40 would begin to approach a linear relationship with one another. The rotational movement about the respective pivot points as a result of the upward force being asserted by the associated lifting apparatus causes the first and second tong awns 14, 16 to be drawn towards one another, thereby shortening the effective length of the first interior face 18. The tension created by the opposing interior faces of the respective tong arms 14, 16 as they are drawn towards one another allows for the load lifting apparatus 100 to securely grasp a load 10.

With continued reference to FIG. 1, locking means may be used so as to set the effective width of the first interior face 18 of the first set of tongs 12 by fixing the position of the respective tong arms 14, 16. According to one embodiment, a locking plate 80 may be affixed to the exterior of each of the first and second tong arms 14, 16. The locking plate 80 may have a series of openings, positioned about opposing ends, which are capable of receiving an associated fastener. The locking plate 80 may be positioned such that a first opening 82 is positioned about a face of the first tong arm 14, and second opening 84 is positioned about a face of the second tong arm 16. An associated fastener may be inserted into each of the respective openings 82, 84 so as to lock the respective tong arms 14, 16 in place and set an effective width of the first interior face 18.

As the associated lifting device ceases the exertion of an upward force on the load lifting apparatus 100, the spacing between the tong arms 14, 16 may be retained by the locking plate 80, or by alternative means as identified by those having skill in the art. When the locking plate 80, or any other associated locking device, is not engaged, the effective width of the first interior face 18 may be increased by exerting a downward force on the transverse member 70, towards that of the associated load 10. As the associated lifting apparatus exerts this downward force on the transverse support member 70, the first linkage members 32, 42 of the respective first and second linkages 30, 40 are caused to pivot about the first anchoring pivot point 76. This pivoting or rotational movement causes the respective first linkage members 32, 42 to retract horizontally such that they begin to approach the same horizontal plane as that of the transverse support member 70.

As the first linkage members 32, 42 rotate about the first anchoring pivot point 76, the downward force by the associated lifting apparatus will also cause the second linkage members 34, 44 to pivot about the first and second linkage pivot points, 36, 46. This rotational movement causes the second linkage members 34, 44 to begin to retract such that each of the first linkage member 32 and second linkage member 34 of the first linkage 30 and first linkage member 42 and second linkage member 44 of the second linkage 40 are drawn towards one another. If the rotational movement about the various pivot points 36, 46, and 76 were uninhibited, the first and second linkage members 32, 34 of the first linkage 30 and the first and second linkage members 42, 44 of the second linkage 40 would begin to approach a spatial relationship wherein the respective linkage members are substantially collapsed on top of one another. The rotational movement about the respective pivot points as a result of the downward force being asserted by the associated lifting apparatus causes the first and second tong arms 14, 16 to be pushed away from one another, thereby extending the effective length of the first interior face 18. This results in a release of tension created by the opposing interior faces of the respective tong arms 14, 16 as they are pushed apart and allows for the load lifting apparatus 100 to release the associated load 10.

The configuration of the various tong arms and linkages causes the first set of tongs 12 to retain a relatively stable spatial relationship such that the interior faces of the respective tong arms 14, 16 are capable of engaging the sides of the associated load 10 to create a flush, or substantially flush, connection. This stability creates for a more secured grasping of the associated load 10.

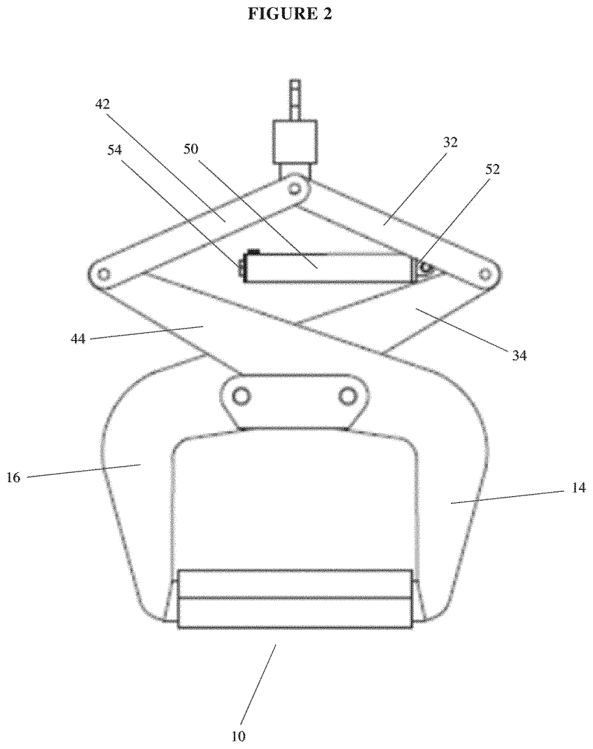

With reference now to FIGS. 1 and 2, a first hydraulic cylinder 50 may be associated with the first and second linkages 30, 40. A second hydraulic cylinder 60 may similarly be associated with the corresponding pair of linkages associated with the second set of tongs 20. Each of the first and second hydraulic cylinders 50, 60 are capable of assisting the respective linkages in both the extension and retraction of the respective tong arms. The first hydraulic cylinder 50 may be positioned on the interior of the first linkage 30, between that of the first linkage member 32 and second linkage member 34. Alternatively, the location of the first hydraulic cylinder 50 may also be inverted such that it is located on the second linkage 40, between that of the first linkage member 42 and second linkage member 44.

According to the embodiment shown in FIG. 1, the first hydraulic cylinder 50 is positioned on the interior of the first linkage 30, between that of the first linkage member 32 and the second linkage member 34. A first end of the first hydraulic cylinder 50 may comprise an end cap 52 affixed between that of the first and second linkage members 32, 34, positioned adjacent to that of the first linkage pivot point 36. The barrel 54 of the first hydraulic cylinder 50 extends outward and away from the first pivot point 36 and towards the second pivot point 46 of the second linkage 40. According to certain embodiments, the piston rod 56, located about the opposing distal end of the barrel 54 of the first hydraulic cylinder 50, may extend away from the barrel 54 and towards the second linkage pivot point 46. The spacing between the plates of the second linkage member 44 of the second linkage 40 may provide an opening through which the piston rod may extend through.

With continued reference to FIG. 2, the first hydraulic cylinder 50 is shown positioned between the first and second linkage members 32, 34 of the first linkage 30. The linkage members 32, 34 are shown in a partially compressed state, with the first and second tong arms 14, 16 engaging a load 10. This configuration leaves the first hydraulic cylinder 50 also in a partially compressed state.

With reference now to FIG. 3, a connecting member 68 bridges the gap between that of the first and second tongs 12, 20, joining the two members together. The connecting member 68 runs substantially parallel to that of the transverse member 70. The alignment of the various plates which comprise each of the first and second set of tongs 12, 20 are shown. Each of the various components are thus designated by their corresponding part as shown in FIGS. 1 and 2 above, with the addition of a letter reference “A” showing that the component is a substantial reproduction of the component designated by the original reference character.

The two plates comprising the first tong arm 14, plates 14A and 14B, are shown, with the two plates comprising the second tong arm 16, plates 16A and 16B, interconnected, with plate 16A being positioned between that of plates 14A and 14B. According to a similar configuration, the two plates comprising the second linkage member 44 of the second linkage 40, plates 44A and 44B, are shown, with the two plates comprising the second linkage member 34 of the first linkage 30, plates 34A and 34B, interconnected, with plate 34A being positioned between that of plates 44A and 44B. According to a similar configuration, the two plates comprising the first linkage member 42 of the second linkage 40, plates 42A and 42B, are shown, with the two plates comprising the first linkage member 32 of the first linkage 30, plates 32A and 32B, interconnected, with plate 32A being positioned between that of plates 42A and 42B.

The load lifting apparatus 100 may further be equipped with a control system chosen according to the judgment of those having skill in the art. For example, the control system may be capable of producing a control signal that can be sent to the first hydraulic cylinder 50 to cause the hydraulic cylinder 50 to actuate, thereby assisting the movement of the associated tong arm 12 according to the pivotal rotation of the linkages 30, 40 about the respective pivot points. In a similar manner, the control system may send a similar signal to the second hydraulic cylinder 60. According to the embodiment shown in FIGS. 1-3, the control signal sent to each of the hydraulic cylinders 50, 60 will dictate movement of the respective cylinders in the same direction such that the corresponding tong arms 12, 20 are driven in unison, and not independently of one another.

The ability to operate the hydraulic cylinders 50, 60 by way of a control system allows for the load lifting apparatus 100 to be operated independent of an associated lifting device, such as a crane. This allows for the effective length of the first interior face 18 to be adjusted in anticipation of a load to be grasped by the corresponding tong arms 12, 20. Operation of the hydraulic cylinders 50, 60 via the control system also permits the load lifting apparatus 100 to release a load in the absence of exerting a downward force on the transverse member 70.

As described above, the present disclosure has been described in association with various aspects thereof and it is understood that many changes and modifications to the described aspects can be carried out without departing from the scope and the spirit of the present disclosure at is intended to be limited only by the appended claims.

Having thus described the invention, it is now claimed:

What is claimed is:

1. An apparatus comprising:
a first linkage comprising first and second linkage members pivotally coupled to one another about a first pivot point;
a second linkage comprising first and second linkage members pivotally coupled to one another about a second pivot point;
a first set of tongs comprising a first tong arm and a second tong arm; and,
a first hydraulic cylinder capable of actuating about the first pivot point;
wherein the distance between the first and second tong arms are adjustable based upon the pivotable relation between the first and second linkage.

2. The apparatus of claim 1, further comprising a transverse support member.

3. The apparatus of claim 2, wherein said first and second linkage are pivotally coupled to the transverse support member about a third pivot point.

4. The apparatus of claim 3, further comprising a third linkage comprising first and second linkage members pivotally coupled to one another about a fourth pivot point.

5. The apparatus of claim 4, further comprising a fourth linkage comprising first and second linkage members pivotally coupled to one another about a fifth pivot point.

6. The apparatus of claim 5, further comprising a second set of tongs comprising a first tong arm and a second tong arm.

7. The apparatus of claim 6, further comprising a second hydraulic cylinder capable of actuating about the third pivot point.

8. The apparatus of claim 1, further comprising a connecting member between the first and second set of tongs.

9. The apparatus of claim 1, further comprising a locking mechanism for fixing the distance of said first and second tong arms.

10. The apparatus of claim 1, further comprising at least one attachment point for affixing the apparatus to an associated lifting device.

11. The apparatus of claim 1, further comprising at least two attachment points for affixing the apparatus to an associated lifting device.

12. The apparatus of claim 1, further comprising a control system for controlling at least the first hydraulic cylinder.

13. The apparatus of claim 7, further comprising a control system for controlling at least the first and second hydraulic cylinders.

14. A method of manipulating a load with a lifting apparatus, comprising the steps of:
affixing a load lifting apparatus to an associated lifting device, the load lifting apparatus comprising:
a transverse support member to which the associated lifting device is affixed;
a first linkage comprising first and second linkage members pivotally coupled to one another about a first pivot point;
a second linkage comprising first and second linkage members pivotally coupled to one another about a second pivot point;
a first set of tongs comprising a first tong arm and a second tong arm; and,
a first hydraulic cylinder capable of actuating about the first pivot point;
adjusting the distance between the first and second tong arms relative to the width of the load;
placing the first and second tong arms about opposing ends of the load;
readjusting the distance between the first and second tong arms to engage the load; and,
operating the lifting apparatus to manipulate the load.

15. The method of claim 14, where the first and second linkage of the load lifting apparatus are pivotally coupled to the transverse support member about a third pivot point.

16. The method of claim 15, wherein the distance between the first and second tong arms are adjusted and readjusted according to actuation of the first hydraulic cylinder.

17. The method of claim 16, where the load lifting apparatus further comprises a control system for controlling at least the first hydraulic cylinder.

18. The method of claim 17, where the load lifting apparatus further comprises:
a third linkage comprising first and second linkage members pivotally coupled to one another about a fourth pivot point;
a fourth linkage comprising first and second linkage members pivotally coupled to one another about a fifth pivot point;
a second set of tongs comprising a first tong arm and a second tong arm; and,
a second hydraulic cylinder capable of actuating about the third pivot point.

19. The method of claim 18, where the load lifting apparatus further comprises a locking mechanism for fixing the distance of at least said first and second tong arms, further comprising the step of:
activating the locking mechanism to fix the distance of at least said first and second tong arms.

20. A load lifting apparatus comprising:
a transverse support member;
a first linkage comprising a first linkage member and a second linkage member, where said first and second linkage members are pivotally coupled to one another about a first pivot point;
a second linkage comprising a first linkage member and a second linkage member, where said first and second linkage members are pivotally coupled to one another about a second pivot point and said first and second linkage are further pivotally coupled to the transverse support member about a third pivot point;
a first set of tongs comprising a first tong arm and a second tong arm, where said first tong arm is an extension of the second linkage member of said first linkage and the second tong arm is an extension of the second tong arm of said second linkage;
a third linkage comprising a first linkage member and a second linkage member, where said first and second linkage members are pivotally coupled to one another about a fourth pivot point;
a fourth linkage comprising a first linkage member and a second linkage member, where said first and second linkage members are pivotally coupled to one another about a fifth pivot point and said third and fourth linkage are further pivotally coupled to the transverse support member about a sixth pivot point;
a second set of tongs comprising a first tong arm and a second tong arm, where said first tong arm is an extension of the second linkage member of said third linkage and the second tong arm is an extension of the second tong arm of said fourth linkage;
a first hydraulic cylinder capable of actuating about the first pivot point to drive the first and second linkage members of the first and second linkage; and,
a second hydraulic cylinder capable of actuating about the third pivot point to drive the first and second linkage members of the third and fourth linkage;
wherein the distance between each of the first and second tong arms of the first and second set of tongs are adjustable based upon the pivotable relation between the various linkages.
